(19) United States
(12) Patent Application Publication
(10) Pub. No.: US 2015/0247628 A1
(43) Pub. Date: Sep. 3, 2015

(54) Portable Lighting Apparatus

(71) Applicant: Black & Decker Inc., Newark, DE (US)

(72) Inventor: Penny Li, Jiangsu (CN)

(73) Assignee: Black & Decker Inc., Newark, DE (US)

(21) Appl. No.: 14/658,715

(22) Filed: Mar. 16, 2015

Related U.S. Application Data
(63) Continuation of application No. PCT/CN2014/073484, filed on Feb. 14, 2014.

(51) Int. Cl. F21V 21/29; F21V 29/70; F21L 4/00

(52) U.S. Cl. CPC F21V 21/29; F21L 4/005; F21V 29/70; F21Y 2101/02

(57) ABSTRACT

A handheld lighting apparatus comprises a light head which is mounted on a first housing and projects from a second housing on which a battery pack is mounted. The first housing is pivotally joined to the second housing at a pivotal joint and is pivotally moveable about a pivotal axis to change inclination of the light head relative to the second housing. The light head is retainable at one of a plurality of predetermined inclination angles relative to the pivotal axis.

### CROSS-REFERENCE TO RELATED APPLICATIONS

This application is a continuation of co-pending International Application No. PCT/CN2012/073484 filed Mar. 14, 2014.

### FIELD OF THE DISCLOSURE

The present disclosure relates to portable lighting, and more particularly, to portable lighting apparatus in the form of handheld area lights.

### BACKGROUND AND SUMMARY

Portable lighting provides a convenient mobile luminance source. Portable lighting usually comes in the form of flash lights which are directional or area lights which are non-directional. Known portable lighting apparatus such as known flash lights often produce too localized lighting and lighting coverage of known area lights are often too rigid for multipurpose use.

There is provided a handheld lighting apparatus comprising a light head. The light head is in the form of an area light mounted on a first housing and projects from a second housing on which a battery pack is mounted. The first housing is pivotally joined to the second housing at a pivotal joint and is pivotally moveable about a pivotal axis to change inclination of the light head relative to the second housing; and wherein the light head is retainable at one of a plurality of predetermined inclination angles relative to the pivotal axis.

The lighting emitting surface may pivot through more than 90°, including more than 120°, further including more than 135°, and up to 144°, when progressing through the plurality of predetermined inclination angles relative to the pivotal axis.

The lighting emitting surface may pivot through the plurality of predetermined inclination angles relative to the pivotal axis at predetermined angular steps, and each predetermined angular step being at an angular range of 10°-16°.

The light head may emit over 200 Lumens, including over 225 Lumens, further including 300 Lumens, even further including 400 Lumens.

### BRIEF DESCRIPTION OF THE DRAWINGS

The disclosure will be described by way of example with reference to the accompanying Figures, in which:

FIG. 1 is a schematic diagram depicting a perspective view of an example portable lighting apparatus disclosed herein,

FIGS. 2 and 3 are schematic diagrams depicting perspective views of the portable lighting apparatus of FIG. 1 at different inclination configurations,

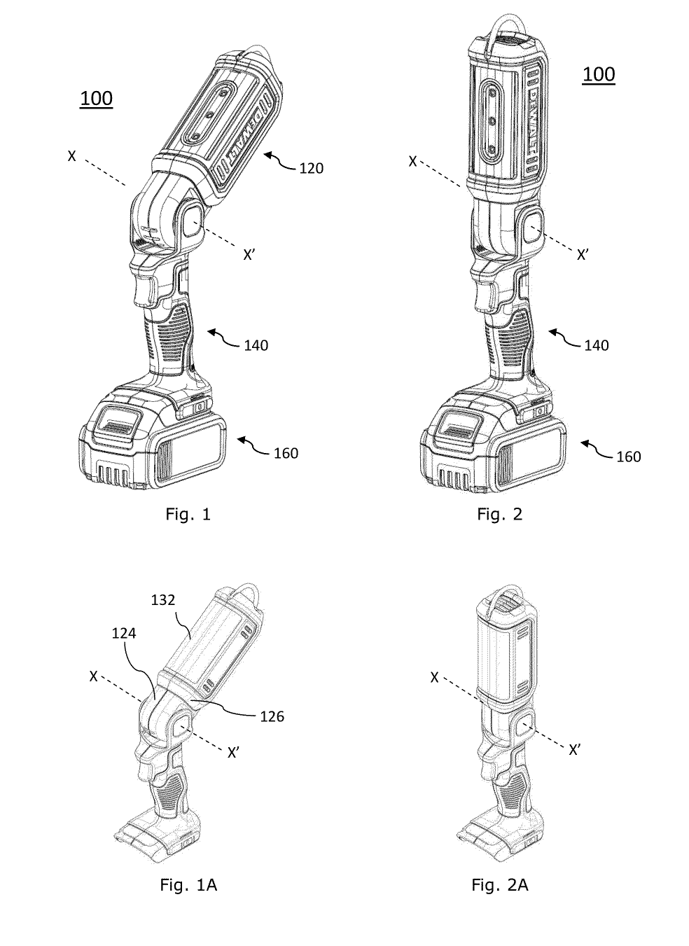

FIGS. 1A, 2A and 3A are schematic diagrams respectively of the perspective views of FIGS. 1, 2 and 3 but without battery pack and not showing the lighting module,

FIGS. 4, 5 and 6 are schematic diagrams respectively show a front view, a side view and a rear view of the example portable lighting apparatus of FIG. 1 in the inclination configuration of FIG. 2,

FIG. 7 is a schematic diagram showing the example portable lighting apparatus at various inclination configurations,

FIG. 8 is a longitudinal cross-section view of the example portable lighting apparatus of FIG. 1 in the inclination configuration of FIG. 2 (the cross of FIG. 8 is not part of the drawing),

FIG. 9 is a schematic view showing the upper portion of the example portable lighting apparatus,

FIG. 9A is a schematic view exploding parts of FIG. 9,

FIG. 10 is a schematic view showing the lower portion of the example portable lighting apparatus,

FIG. 10A is a schematic view exploding parts of FIG. 10, and

FIG. 10B depicts a series of indentations surrounding the pivot shaft of FIG. 10.

### DETAILED DESCRIPTION

An example portable lighting apparatus in the form of a handheld area light 100 is depicted in FIGS. 1 to 3. The example area light 100 comprises an upper portion 120, a lower portion 140 in hinged connection with the upper portion 120, and a battery pack 160 (not shown in FIG. 1) connected to the lower portion at an end that is distal to the end connected to the upper portion 120. The upper portion includes a light head which is the source of electrical luminance of the area light 100. The light head projects away from the lower portion 140 and is pivotally movable relative to the lower portion about a pivotal axis X-X′ to change the projection configuration or inclination configuration of the light head relative to the lower portion 140. The angular configuration of the upper portion can progressively or continuously change from projecting from one side of the lower portion or pivotal axis to projecting from another, opposite, side of the lower portion or the pivotal axis by applying a turning force about the pivotal axis X-X′. The area light 100 includes a retention mechanism to retain the upper portion 120 at one of a plurality of predetermined angular configurations.

The upper portion 120, and therefore the light head, is retainable at one of a plurality of predetermined inclination configurations relative to the lower portion by the retention mechanism. Each inclination configuration corresponds to a unique angular inclination relative to the lower portion or the pivotal axis X-X′.

In the configuration of FIGS. 1 and 1A, the upper portion 120 projects rearwards of the lower portion and is retained at a first angular configuration. In this configuration, its light emitting surface is facing upwards at an angular inclination to the pivotal axis X-X′ and the upper portion 120 is at an angular elevation to the pivotal axis X-X′.

In the configuration of FIGS. 2, 2A, and 4-6, the upper portion 120 projects directly above the lower portion and is retained at a second angular configuration such that the upper portion is aligned or substantially aligned with the lower portion 140. In this configuration, the light emitting surface is level facing or substantially level facing in a forward direction.

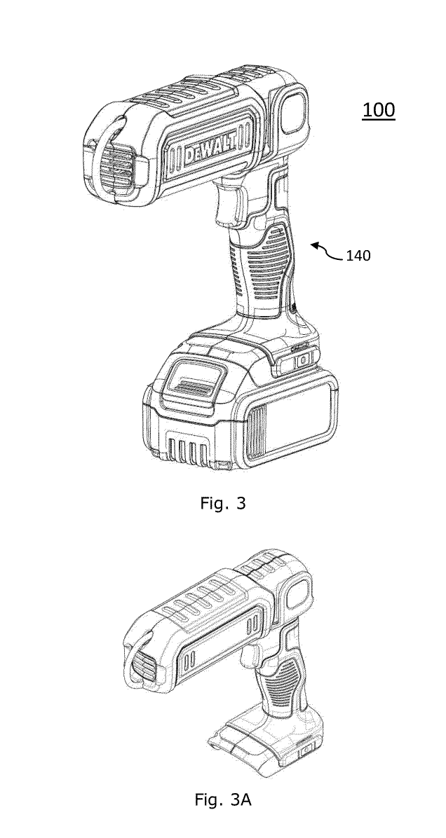

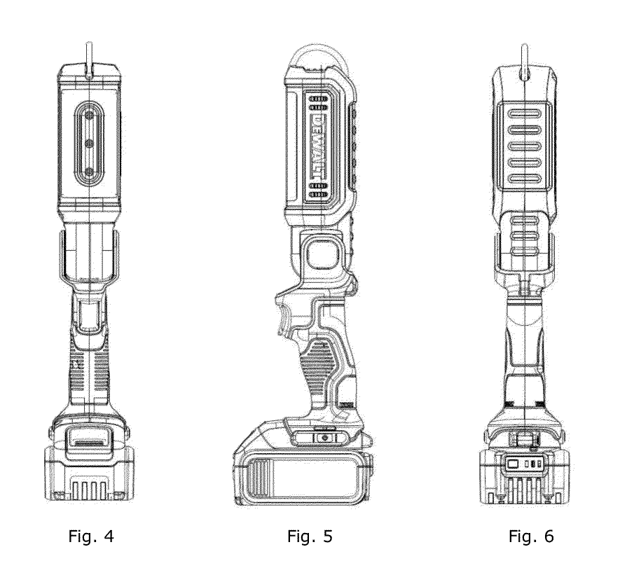

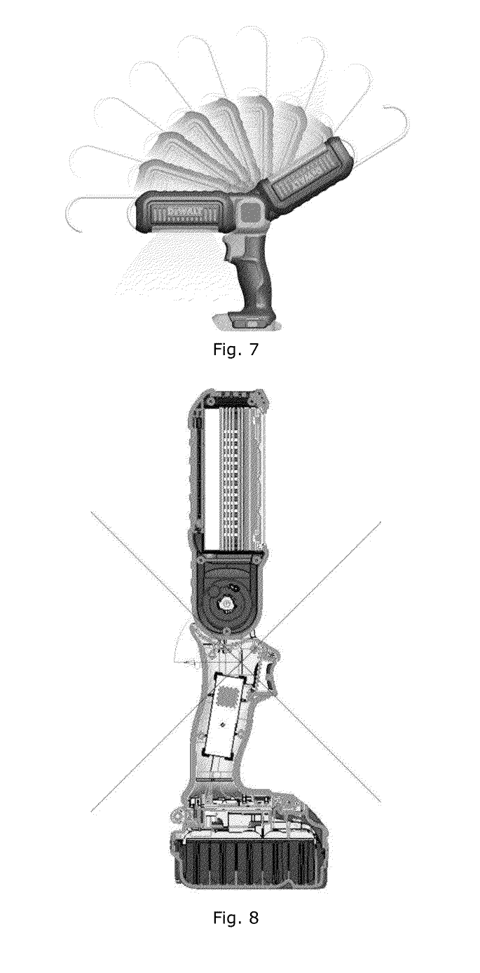

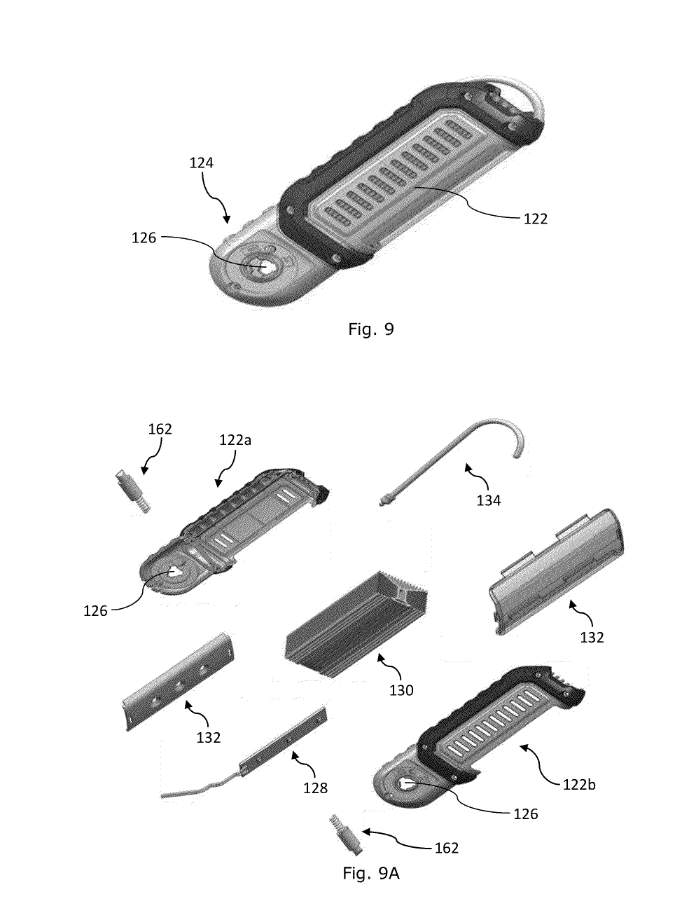

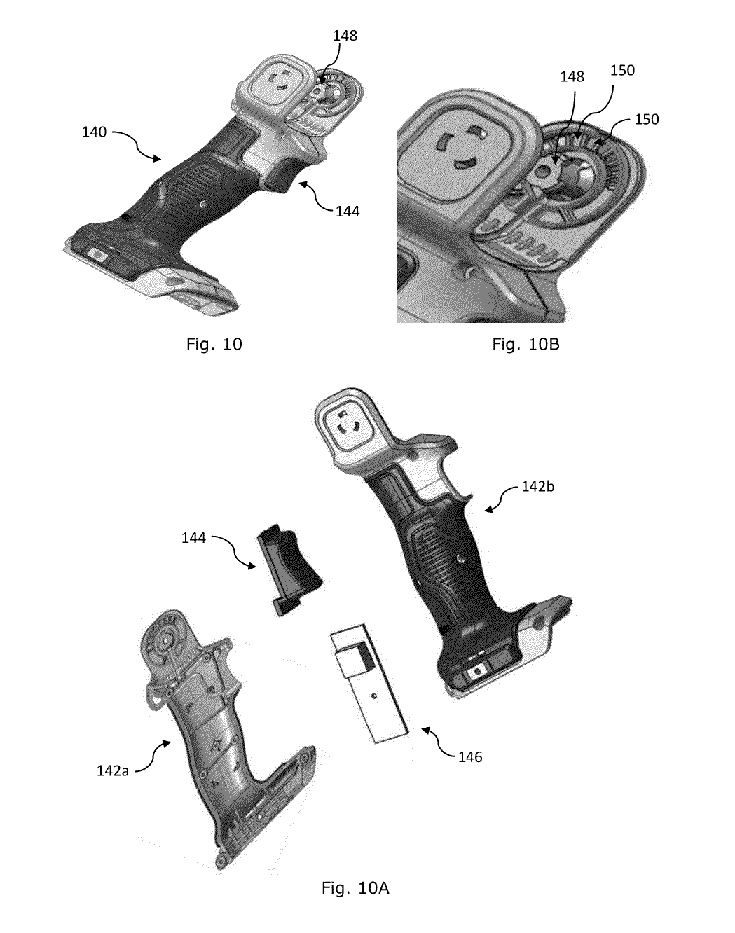

In the configuration of FIGS. 3 and 3A, the upper portion 120 projects forward of the lower portion and is retained at a third angular configuration. In this configuration, the light emitting surface is facing downward and the upper portion 120 is leveled or substantially leveled.

Referring to FIGS. 9 and 9A, the upper portion 120 includes a light head receptacle to hold the light head and an upper hinge housing at a lengthwise end for making hinged connection with the lower portion 140. The light head receptacle defines a hollow compartment for receiving components of the light head and a through aperture is formed on the upper housing 122 to define a window aperture of the hollow compartment. A lens 132 is mounted on the window aperture to form an illumination window of the light head. The hollow compartment has a substantially uniform cross-section along its length, and the cross-section profile is in the shape of a rounded polygon, such as a rounded square or a rounded rectangle. A retractable hang hook 134 is received in the upper housing and extendable from the upper housing at the end distal to the hinge portion.

Clam shells 122a, 122b that are moulded of hard plastics and are fastened together to form the upper housing 122. Each of the clam shells 122a, 122b has a generally “L” shape cross-section along the length that defines the compartment to form the upper housing 122 that is hollow, and the cross-sections of the clam shells 122a, 122b are substantially mirror symmetrical. The clam shells 122a, 122b cooperate to define a hollow compartment having the generally polygonal cross-sectional profile when fastened together. The portion of a clam shell 122a, 122b that forms part of the upper hinge housing is a free end portion that extends from a lengthwise end of the hollow compartment. This upper hinge housing forming portion projects away from the hollow compartment in a lengthwise direction and has a rounded or substantially semi-circular profile about a lateral axis which is orthogonal to the lengthwise direction. The free end portion is in the form of a cup-shaped end cap portion 124.

The cup-shaped end cap portion 124 includes a peripheral wall which extends from a bottom portion in a lateral direction that is parallel to a lateral axis which is parallel to the pivotal axis. The peripheral wall extends in a lengthwise direction to join the peripheral walls that define the hollow compartment. The bottom portion has a circular or substantially circular shape and a hinge aperture 126 is defined at about the centre of the substantially circular bottom portion. The hinge axis of the hinge connection between the upper housing and lower housing also passes through centre of the bottom portion. The cross-sectional profiles of the end cap portions 124 of the clam shells 122a, 122b are substantially mirror symmetrical. The peripheral wall and the bottom portion of each end cap portion 124 cooperate to define a recess. When the clam shells 122a, 122b are fastened together, free edges of the corresponding peripheral walls of the oppositely facing end cap portions 124 are in urging engagement with each other to define the hinge housing, and the recesses of the oppositely facing corresponding end cap portions 124 define a hollow upper hinge compartment.

The light head comprises light emitting diodes (LED) that are mounted on a printed circuit board to form an LED module 128. The LED module obtains operation power from the battery pack 160 and operating power to the LED module is supplied by a power cable which passes through the lower portion 140. The LEDs are arranged into an LED array and each LED array includes a plurality of light emitting diodes. The light emitting diodes in an array are distributed along the lengthwise direction of the hollow compartment. In some embodiments, the LED module comprises a plurality of LED arrays to form a matrix of LED. An aluminium heat sink 130 with integrally formed heat dissipation fins is contiguously mounted to the back of the printed circuit board. A light reflector 132 having a reflective surface is mounted on the compartment to couple light emitted by the LED array to emerge through the illumination window of the compartment. A plurality of apertures is defined on the reflector to expose individual LEDs. The LED module 128 is mounted on the upper housing such that the reflective surface of the reflector and the light emitting surfaces of the LED are facing the illumination window, and the heat sink 130 is disposed inside the compartment and behind the reflector. The lens 132 is mounted on the upper housing to form the illumination window. The portion of the upper housing that is opposite and distal to the illumination window defines an opaque back housing to the light head. The elongate heat sink is received between the reflector and the light head back housing.

The LED module 128, the reflector 132 and the lens 132 in combination form the light head which is to generate diffused light to cover an area during illumination operation. Therefore, the apparatus is referred to as an “area light”. The length of the heat sink is comparable to that of the compartment to promote maximized heat dissipation. The heat dissipation fins are distributed along the length of the heat sink and each heat dissipation fin extends radially from the main body of the heat sink to promote heat dissipation. In some embodiments, a combination of the reflector and the lens light head may be non-diffusing to make the light head more directional. The example LED module comprises 3 LED and gives an output of 225-450 Lumens.

Referring to FIGS. 10 and 10A, the lower portion 140 is hinged joined to the upper housing 120 and is pivotally moveable relative to the upper housing 122 about the pivotal axis X-X′. The pivotal axis is orthogonal to the lengthwise direction of the lower portion 140. The lower portion 140 includes a lower housing 142 that is hollow and constructed from two elongate clam shells 142a, 142b. The clam shells 142a, 142b are moulded of hard plastics and are fastened together to form the lower housing 142. The lower housing 142 includes a handle housing, a lower hinge housing, and a battery attachment housing.

The hinge housing and the battery attachment housing are at opposite lengthwise ends of the handle housing. The handle portion is shaped and dimensioned to receive a hand of a user to facilitate handheld operation of the area light 100. A handgrip portion comprising a finger grip portion and a palm grip portion is formed on the handle portion. The finger grip portion and the palm grip portion are on opposite sides of the handle portion or on opposite sides of the pivotal axis. The finger grip portion defines a forward side of the light 100 and the palm grip portion defines a backward or rearward side of the light for convenience of reference. The handgrip portion has a substantially rounded profile along its length to resemble a handgrip profile. A power switch 144 is provided on the handle portion near the hinge housing to facilitate thumb switching of the light head by a user during handheld operations. A user is to operate the power switch to turn on and turn off the light 100. A power supply circuit in the form of a power module 146 is mounted inside the handle portion and is connected to both the battery pack and the LED module to supply operating power to the LED module when the power switch is at an “ON” position.

The lower hinge housing is to enter into mechanical coupling with the upper hinge housing to form a pivot joint having the pivotal axis. The pivot joint facilitates relative pivotal move of the upper portion 120 relative to the lower portion 140 about the pivotal axis X-X′ when a turning force is applied on the upper portion and about the pivotal axis.

This lower hinge housing includes a pair of hinge ends. The pair of hinge ends defines a pair of pivot arms to hold the upper hinge housing to permit relative pivotal movement of the upper portion about the pivot axis. Each hinge end comprises an end plate member that extends upwardly from the handle portion in a lengthwise direction and away from the battery attachment housing to define height of the lower hinge housing. The end plate member extends forward and rearward of the pivotal axis to define width of the lower hinge housing. The end plate members are parallel and are spaced apart for closely fitted reception of the upper hinge housing. The end plate members collectively define outer walls of the lower hinge housing and the upper hinge housing is received between the outer walls.

Each hinge end includes a pivot shaft portion 148. The pivot shaft portion protrudes from centre of the end plate member and projects laterally into the hinge aperture 126 on the upper hinge housing. The pivot shaft portions of the pair of hinge ends extend towards each other and aligned in a coaxial manner to define the pivotal axis of the pivotal joint connecting the upper and lower portions.

A series of indentations 150 is arranged in a circular path surrounding the pivot shaft portion 148 as depicted in FIGS. 10 and 10B. The series of indentations comprises a plurality of N indentations and each indentation is shaped so that when a latching device that is mechanically coupled or mechanically connected to the upper housing is received inside one of the plurality of indentations, the upper portion will be retained at one of a plurality of inclination angles relative to the lower portion. The inclination angle is an angle between a longitudinal axis of the upper portion and a longitudinal axis of the lower portion. The longitudinal axis of the upper portion is an axis that passes through the elongate upper housing in the lengthwise direction of the upper housing, and the longitudinal axis of the lower portion is an axis that passes through the elongate lower housing in the lengthwise direction of the upper housing. The inclination angle can be represented as the angle between the longitudinal axis of the upper portion and the pivotal axis where appropriate.

The indentations are distributed in a circular path around the pivotal shaft portion, with the pivotal portion being centre of the circular path, such that the angular inclination of each indentation relative to the pivotal shaft portion corresponds to one of the plurality of inclination angles of the upper portion. The N indentations define the N discrete inclination angles at which the upper portion can be retained. When the upper portion moves through the N indentations, the upper portion will have traversed through N angular steps and covers an angular range θ. Each angular step contains an angle φₘ where n is any of 1 to N, N being an integer.

In the example depicted in FIGS. 10 and 10B, there are 9 indentations so that N=9. The total angle covered by pivotal movement of the upper portion about the pivotal axis after having traversed through the 9 indentations is θ=144°, and each angular step covers an angle φₙ of 15°. The upper portion 120 is retainable at one of the 9 inclination configurations as depicted in FIG. 7.

The angular coverage of the individual angular steps may be differently set according to requirements without loss of generality. A convenient example angular step size is between 12-20°. The total number of indentations is variable and a convenient example range is 8-15 indentations. The total or maximum angular range is also variable and a convenient example range is 60°-180°.

The latching device and the series of indentions cooperate to define a retention mechanism to retain the upper portion in one of plurality of inclination angles. The inclinations angles are also referred to as inclination configurations where appropriate.

An example latching device depicted in FIGS. 9 and 9A comprises a latching assembly 162 comprising a detent and a coil spring. The latching assembly 162 is mounted on the upper housing 120 with the detent urged by the associated spring towards the indentations when in the assembled form. When the detent is received by an indentation, the upper portion is retained at the angular configuration defined by that indentation.

The detent includes a rounded head that is received by an indentation. When a turning force exceeding a predetermined threshold is applied to the upper housing, the rounded head upon encountering a side of the indentation will be driven out of the indentation against spring urge. When the head of the indent is next received by an indentation, the indent will stay in the indentation if the turning force is removed or if the turning force is below a threshold. The spring urge associated with the indent is arranged such that the weight of the upper portion is not sufficient to drive the indent out of an indentation.

The battery attachments having flames as it extends downwards and includes a battery latch to releasably receive the battery pack 160.

In some embodiments, the indentations may be on the upper housing and the indent on the lower housing. In some embodiments, the retention mechanism may comprise a ratchet mechanism or a pin-and-hole mechanism.

In use, a user will operate the power switch to turn on or turn off power supply to the LED module when the upper housing is at an angular configuration. When it is desirable to change the angular configuration, a user will then apply a turning force in the direction of intended turn. For example, a user may grip the upper portion and apply a turning force. When the applied turning force exceeds a predetermined threshold, the retention force will be overcome and the upper portion will traverse indentations when the turning force is removed or below the threshold and the indent received in an indentation. The upper portion may move from one extreme of FIG. 1 and another extreme of FIG. 3. The upper portion may move from one angular position which is between the extreme angular positions to another angular position that is also between the extreme angular positions.

An example battery pack comprises a Lithium ion battery pack. The battery pack has a weight that is sufficient to support an overhanging upper portion at all possible angular configuration between the extreme configurations.

While the disclosure has been described herein with reference to examples, the examples are not intended and should not be used to limit the scope of disclosure. For example, while LED has been used an example, other lighting elements of sufficient power and luminance performance may be used.

Reference numerals at a glance:

| | | | |
|---|---|---|---|
| 100 | Area light | | |
| 120 | Upper portion | 140 | Lower portion |
| 122a,122b | Clam shells | 142a,142b | Clam shells |
| 124 | End cap portion | | |
| 126 | Hinge aperture | 146 | Power module |
| 128 | LED module | 148 | Pivot shaft portion |
| 130 | Heat sink | 150 | Indentations |
| 132 | Window lens | | |
| 134 | Hang hook | | |
| 160 | Battery pack | 162 | Latching assembly |

1. A handheld lighting apparatus comprising:
a first housing;
a second housing on which a battery pack is mounted; and
a light head mounted on the first housing and projecting from the second housing,
wherein the first housing is pivotally joined to the second housing at a pivotal joint and is pivotally moveable about a pivotal axis to change inclination of the light head relative to the second housing, and the light head is retainable at one of a plurality of predetermined inclination angles relative to the pivotal axis.

2. A handheld lighting apparatus according to claim 1, wherein the second housing includes a handle portion defining a handgrip portion to facilitate hand-held operation and a battery engagement portion in engagement with the battery pack, and the handle portion extends between the pivotal joint and the battery engagement portion.

3. A handheld lighting apparatus according to claim 2, wherein the handle portion is elongate and defines a handle axis that extends between a first end that is proximal the battery engagement portion and a second end that is proximal the pivotal joint, and wherein the light head is pivotally movable between a first projection configuration at which the light head projects from a first side of the handle portion and a second projection configuration at which the light head projects from a second side of the handle portion, the first and second sides being on opposite sides of the handle portion.

4. A handheld lighting apparatus according to claim 3, wherein the first housing is at a first inclination angle to the handle axis or handle portion when in the first projection configuration and at a second inclination angle to the handle axis or the handle portion when in the second projection configuration, and the first housing goes through a decrease in inclination angle relative to the handle portion when moving from the first projection configuration towards the handle axis direction, and an increase in inclination angle relative to the handle portion when moving from the handle axis direction towards the second projection configuration.

5. A handheld lighting apparatus according to claim 2, wherein the second housing flares at the first end to define the battery engagement portion, and the battery engagement portion projects laterally from the handle portion to define a battery attachment portion; wherein a releasable latching mechanism for releasable latching of a battery pack is formed on the battery attachment portion.

6. A handheld lighting apparatus according to claim 1, wherein the second housing defines a handle portion which includes a finger grip portion and a palm grip portion on opposite sides to receive the hand of a user, and wherein the light head projects from the second housing in the direction of the finger grip portion when retained at one of said plurality of predetermined inclination angles relative to the pivotal axis, and projects from the second housing in the direction of the palm grip portion when retained at another one of said plurality of predetermined inclination angles.

7. A handheld lighting apparatus according to claim 6, wherein the battery pack has a major lateral portion that projects laterally from the finger grip portion and extends away from the palm grip portion and a minor lateral portion that projects laterally from the palm grip portion and extends away from the finger grip portion, and the light head includes a light emitting surface that projects laterally from the finger grip portion and extends away from the palm grip portion and faces the major portion of the battery when retained at one of said plurality of predetermined inclination angles.

8. A handheld lighting apparatus according to claim 1, wherein the light head includes a lighting emitting surface, and the light emitting surface progresses from upward facing to downward facing when pivoting through the plurality of predetermined inclination angles relative to the pivotal axis, the light emitting surface facing away from the battery pack when in upward facing.

9. A handheld lighting apparatus according to claim 8, wherein the lighting emitting surface progress through level facing when the light emitting surface progresses from upward facing to downward facing.

10. A handheld lighting apparatus according to claim 8, wherein the lighting emitting surface pivots through more than 90°, including more than 120°, further including more than 135°, and up to 144°, when progressing through the plurality of predetermined inclination angles relative to the pivotal axis.

11. A handheld lighting apparatus according to claim 8, wherein the lighting emitting surface pivots through the plurality of predetermined inclination angles relative to the pivotal axis at predetermined angular steps, and each predetermined angular step being at an angular range of 10°-16°.

12. A handheld lighting apparatus according to claim 1, wherein the light head includes an array or arrays of light emitting diodes, a light reflector coupled to the light emitting diodes and a heat sink to dissipate heat generated by the light emitting diodes during lighting operation, and wherein the light head including the heat sink projects from the second housing when retained at more than one of the plurality of predetermined inclination angles relative to the pivotal axis.

13. A handheld lighting apparatus according to claim 1, wherein a retention mechanism is provided to retain the light head and/or the first housing at one of a plurality of predetermined inclination angles relative to the pivotal axis, and retention by the retention mechanism is releasable by application of a turning force exceeding a predetermined threshold on the first or the second housing to cause relative pivotal motion between the first and the second housing.

14. A handheld lighting apparatus according to claim 13, wherein the retention mechanism comprises a spring urged pin which is to form a releasable engagement with a corresponding detent device, the detent device defining a plurality of detent apertures such that one of the detent apertures is to receive and retain an end of the spring urged pin when in a retention engagement when the light head is retained at one of the plurality of predetermined inclination angles relative to the pivotal axis, and the spring urged pin is driven out of said detention aperture against spring urge when subject to a turning force about the pivotal axis that exceeds said predetermined threshold.

15. A handheld lighting apparatus according to claim 1, wherein the light head is configured to emit over 200 Lumens.

16. A handheld lighting apparatus according to claim 1, wherein the light head is configured to emit over 225 Lumens.

17. A handheld lighting apparatus according to claim 1, wherein the light head is configured to emit over 300 Lumens.

18. A handheld lighting apparatus according to claim 1, wherein the light head is configured to emit over 400 Lumens.

19. A handheld lighting apparatus according claim 1, wherein the battery pack is adapted to function as ballast or weight to support the light head, the first housing and the second housing on a support surface, and to function as a counterweight to balance the weight of the light head when the light head projects away from the second housing when at one of a plurality of predetermined inclination angles relative to the pivotal axis.
